(19) United States
(12) Patent Application Publication
(10) Pub. No.: US 2014/0009287 A1
(43) Pub. Date: Jan. 9, 2014

(54) INFORMATION PROCESSOR APPARATUS, METHOD, AND PROGRAM

(71) Applicant: Sony Corporation, Tokyo (JP)

(72) Inventors: Gakuho Fukushi, Tokyo (JP); Yuya Horiuchi, Kanagawa (JP); Yoshinori Takagi, Kanagawa (JP); Shinsuke Araya, Kanagawa (JP)

(21) Appl. No.: 13/917,171

(22) Filed: Jun. 13, 2013

(30) Foreign Application Priority Data
Jul. 9, 2012 (JP) 2012-153361

(51) Int. Cl. G08B 21/02

(52) U.S. Cl. CPC G08B 21/02
USPC 340/540

(57) ABSTRACT

There is provided an information processor apparatus including an obtainment unit obtaining food product information related to a determination target food product that is a subject of contraindication determination, a comparison unit identifying, based at least on a drug, a contraindication database including information indicating a contraindication ingredient that is contraindicated with the drug, and the food product information, whether or not the determination target food product contains the contraindication ingredient of the drug that a user takes, and an alert notifying unit issuing an alert notification of a contraindicated combination of the drug and the contraindication ingredient in response to an identification result of the comparison unit.

### CROSS REFERENCES TO RELATED APPLICATIONS

The present application claims priority to Japanese Priority Patent Application JP 2012-153361 filed in the Japan Patent Office on Jul. 9, 2012, the entire content of which is hereby incorporated by reference.

### BACKGROUND

The present disclosure relates to an information processor apparatus, a method thereof and programs thereof, and particularly relates to an information processor apparatus, a method thereof and programs thereof that can provide proper information on drugs and food products more quickly.

Currently, prescriptions issued by doctors, and medication history record books issued by pharmacies are used through printed paper media. However, in order to improve user-friendliness and efficiency, a system to electronically share and manage the prescriptions and medication history record books has been being established.

A technology to print information such as types of drugs and duration of drug use on a drug envelope in two-dimensional code has been proposed (see Japanese Laid-Open Patent Publication JP2010-158478 as an example). In this technology, after a patient takes a drug, the patient causes a mobile terminal to load the two-dimensional code on the drug envelop and to transmit the code to a device on a pharmacy end so that the device on a pharmacy end can obtain information on the drug and its administration for each patient from the mobile terminal. In this manner, it is possible to generate a list of drug administration for each patient.

With reference to this list of drug administration, pharmacists and doctors can prevent prescription of a combination of drugs that are contraindicated when being administered in combination.

### SUMMARY

It has been known that when a particular food product and a particular drug are consumed at the same time, expected efficacy of the drug may be inhibited, and if a patient takes such a contraindicated combination of a drug and a food product without knowing the contraindication, the patient may fall into a serious condition in the worst case.

However, as it stands now, there is no method to provide patients with information on contraindication of combinations between drugs and food products at an early stage, and a technology that can provide proper information on contraindication of combinations instantaneously to patients has been desired.

The present disclosure was made in view of this situation and the present disclosure can provide proper information on drugs and food products more quickly.

According to a first embodiment of the present application, there is provided an information processor apparatus including an obtainment unit obtaining food product information related to a determination target food product that is a subject of contraindication determination, a comparison unit identifying, based at least on a drug, a contraindication database including information indicating a contraindication ingredient that is contraindicated with the drug, and the food product information, whether or not the determination target food product contains the contraindication ingredient of the drug that a user takes, and an alert notifying unit issuing an alert notification of a contraindicated combination of the drug and the contraindication ingredient in response to an identification result of the comparison unit.

The contraindication database may further include information indicating a contraindication food product that possibly includes the contraindication ingredient. The obtainment unit may obtain a food image obtained by capturing an image of the determination target food product or voice corresponding to a food product name of the determination target food product as the food product information. The information processor apparatus may further include a food identifying unit identifying the determination target food product based on the food product information. The comparison unit may identify whether or not the determination target food product contains the contraindication ingredient by comparing an identification result of the food identifying unit with the contraindication database.

When the identification result of the determination target food product identified by the food identifying unit is not correct, the comparison unit may identify whether or not the determination target food product contains the contraindication ingredient by comparing the information indicating the determination target food product input by the user with the contraindication database.

The information processor apparatus may further include a display control unit displaying a food ingredient check screen when the comparison unit identifies that the determination target food product is included in the contraindication food product of the drug that the user takes in the contraindication database, the food ingredient check screen having input through a selection operation whether or not the contraindication ingredient that is an ingredient of the identified contraindication food product is contained in the determination target food product. The alert notifying unit may issue the alert notification in response to an input operation in the food ingredient check screen.

The information processor apparatus may further include a database obtainment unit obtaining the contraindication database.

The information processor apparatus may further include a record unit recording the contraindication database.

The information processor apparatus may further include a communication unit transmitting the food product information, and receiving an identification result of the determination target food product based on the food product information, the identification result being transmitted in response to the transmission of the food product information. The comparison unit may identify whether or not the determination target food product contains the contraindication ingredient by comparing the identification result of the determination target food product with the contraindication database.

The obtainment unit may obtain information indicating a food ingredient of the determination target food product as the food product information. The comparison unit may identify whether or not the food ingredient of the determination target food product is included in the contraindication database as the contraindication ingredient of the drug that the user takes.

According to an embodiment of the present application, there is provided an information processing method and a program, the information processing method including obtaining food product information related to a determination target food product that is a subject of contraindication determination, identifying, based at least on a drug, a contraindication database including information indicating a contraindication ingredient that is contraindicated with the drug, and the food product information, whether or not the determination target food product contains the contraindication ingredient of the drug that a user takes, and issuing an alert notification of a contraindicated combination of the drug and the contraindication ingredient in response to an identification result of whether or not the contraindication ingredient is contained.

According to an embodiment of the present application, food product information related to a determination target food product that is a subject of contraindication determination may be obtained. Based at least on a drug, a contraindication database including information indicating a contraindication ingredient that is contraindicated with the drug, and the food product information, it may be identified whether or not the determination target food product contains the contraindication ingredient of the drug that a user takes. An alert notification of a contraindicated combination of the drug and the contraindication ingredient may be issued in response to an identification result of whether or not the contraindication ingredient is contained.

According to a second embodiment of the present disclosure, there is provided an information processor apparatus including a record unit recording at least a drug, a combination database including information indicating a contraindication ingredient that is contraindicated with the drug and user medication history information on the drug that a user takes, a generation unit generating a contraindication database including information indicating the drug that the user takes and the contraindication ingredient of the drug based on the combination database and the user medication history information, and a communication unit transmitting the contraindication database.

The combination database and the contraindication database may further include information indicating a contraindication food product that possibly includes the contraindication ingredient.

The information processor apparatus may further include a food identifying unit identifying a determination target food product that is a subject of contraindication determination based on food product information on the determination target food product. The communication unit may receive the food product information and transmits an identification result of the determination target food product based on the food product information.

According to a second embodiment of the present disclosure, there is provided an information processing method including generating, based on at least a drug, a combination database including information indicating a contraindication ingredient that is contraindicated with the drug and user medication history information on the drug that a user takes recorded in the record unit, a contraindication database including information indicating the drug that the user takes and the contraindication ingredient of the drug, and transmitting the contraindication database.

According to a second embodiment of the present disclosure, based on at least a drug, a combination database including information indicating a contraindication ingredient that is contraindicated with the drug and user medication history information on the drug that a user takes recorded in the record unit, a contraindication database including information indicating the drug that the user takes and the contraindication ingredient of the drug may be generated. The contraindication database may be generated.

According to embodiments of the present disclosure, it is possible to provide proper information on a drug and a food product more quickly.

Additional features and advantages are described herein, and will be apparent from the following Detailed Description and the figures.

### BRIEF DESCRIPTION OF THE FIGURES

FIG. 1 is a diagram explaining overview of the present disclosure;

FIG. 2 is a diagram illustrating a configuration example of an information processing system;

FIG. 3 is a diagram illustrating a configuration example of a mobile terminal device;

FIG. 4 is a diagram illustrating an example of a user contraindication database;

FIG. 5 is a diagram illustrating a configuration example of an in-pharmacy system;

FIG. 6 is a diagram illustrating a configuration example of a data center;

FIG. 7 is a flowchart explaining user contraindication database storage processing, drug history data transmission processing, and mediation history update processing;

FIG. 8 is a flowchart explaining contraindication determination processing;

FIG. 9 is a diagram illustrating a configuration example of a mobile terminal device;

FIG. 10 is a diagram illustrating a configuration example of a data center;

FIG. 11 is a flowchart explaining contraindication determination processing and food identification processing;

FIG. 12 is a flowchart explaining contraindication determination processing; and

FIG. 13 is a diagram illustrating a configuration example of a computer.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

### Overview of the Present Application

Firstly, an explanation of the overview of the present disclosure is provided.

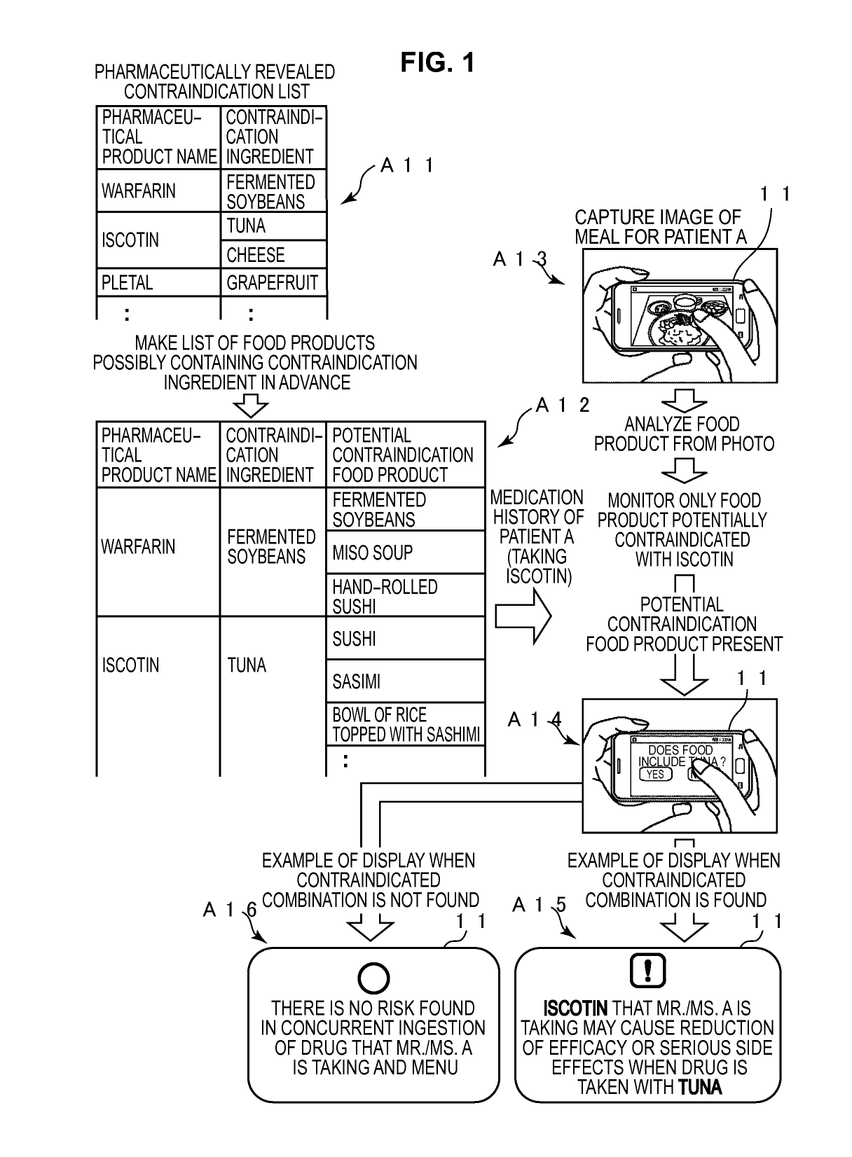

It has been medically and pharmaceutically revealed that for some drugs (pharmaceutical products), certain food ingredients (hereinafter also referred to as contraindication ingredient) cause side effects or inhibit efficacy of the drugs when the food ingredient is consumed while those drugs are taken. In the present disclosure, therefore, a contraindication list, which includes drugs (pharmaceutical products) and contraindication ingredients for each of the drugs as indicated by an arrow A11 in FIG. 1, is used to generate a combination database as indicated by an arrow A12.

The contraindication list indicated by the arrow A11 presents combinations of pharmaceutical product names that are names of drugs and contraindication ingredient against the drugs. For example, it is found that a food ingredient contraindicated with a drug with its pharmaceutical product name of “warfarin” is a contraindication ingredient “fermented soybeans.”

From this list of pharmaceutical product names and contraindication ingredients, as indicated by the arrow A12, a combination database, which provides pharmaceutical product names, contraindication ingredients of respective drugs with the pharmaceutical product names, and food products that may use the contraindication ingredients (hereinafter also referred to as contraindication foods), is generated.

Here, food ingredients refer to ingredients of food products made by cooking (cooked food), and food products refer to food obtained by cooking one or more food ingredients. However, some food ingredients are ready to eat as food products, and such food ingredients themselves may be regarded as food products. For example, “fermented soybeans” can be an ingredient of food products such as “miso soup” and “hand-rolled sushi”, “fermented soybeans” are ingredients of those food products. However, because “fermented soybeans” themselves are edible without cooking, “fermented soybeans” can be a food product.

In the combination database indicated by the arrow A12, a contraindication ingredient against a pharmaceutical product name “warfarin” is “fermented soybeans”, and “fermented soybeans”, “miso soup”, and “hand-rolled sushi” are provided as contraindication foods that may be obtained from the contraindication ingredient “fermented soybeans”.

In the present disclosure, based on the combination database that is prepared in this manner in advance, an alert is issued so that the patient does not take a food ingredient contraindicated with a drug (pharmaceutical product) that a patient is currently taking.

More specifically, when a patient is taking a particular drug, for example, information on the drug that the patient is taking and contraindication ingredients and contraindication foods of the drug is extracted from the combination database, and a user contraindication database is made. Based on the obtained user contraindication database, intake of food ingredients and food products that contraindicate with the drug the patient takes is monitored.

A patient A, for example, is taking “Iscotin” (R) as a drug. In this case, a pharmaceutical product name “Iscotin”, a contraindication ingredient against “Iscotin” “tuna”, and contraindication foods “sushi”, “sashimi”, and “bowl of rice topped with sashimi” are extracted from the combination database indicated by the arrow A12, and a user contraindication database for the patient A is generated.

The user contraindication database generated in this manner is stored in, for example, a mobile terminal device 11 owned by the patient A. The patient A, at mealtimes, takes a photo of the meal (food product) to eat by using the mobile terminal device 11 owned by the patient A, as in an illustration indicated by an arrow A13.

Based on the photo image of the meal taken by the mobile terminal device 11, the food product that the patient A is going to eat is identified by image analysis and the like. Moreover, the identification result is compared with the user contraindication database and whether or not the food product that the patient A is going to eat is a contraindication food is determined.

In the example of the patient A, since the drug that the patient A is taking is “Iscotin”, only the contraindication foods “sushi”, “sashimi”, and “bowl of rice topped with sashimi” may be monitored. For example, when a contraindication food of a drug “Iscotin” is obtained as the food identification result, a food ingredient check screen is displayed on the mobile terminal device 11 to make a user input whether or not the meal includes a contraindication ingredient that is an ingredient of a contraindication food through a selecting operation, as in an illustration indicated by an arrow A14. In this example, the food ingredient check screen displays a text message, “Does the food include tuna?”, to urge selection of whether or not a contraindication ingredient “tuna” is contained in the food product to eat and buttons for the selection. A text “Yes” or “No” is displayed on each of the buttons.

In this state, when the contraindication food “tuna” is included in the food product to eat, the patient A make a setting that the food product includes tuna by operating a button displaying a text “Yes” on the food ingredient check screen.

In this case, the mobile terminal device 11 displays a mark “!” to draw an attention together with an alert message regarding a combination of a drug “Iscotin” that the patient A is taking and a contraindication ingredient “tuna”, as in an illustration indicated by an arrow A15. In this example, as the alert message, “Iscotin that Mr./Ms. A is taking may cause reduction of efficacy or serious side effects when the drug is taken with tuna” is displayed, and in particular, the texts of the drug “Iscotin” and the contraindication ingredient “tuna” are emphasized with different color and different thickness. When the patient A checks this alert message, the patient A may change the menu of the meal or refrains from taking the contraindication ingredient as necessary.

On the other hand, in a state in which the food ingredient check screen indicated by the arrow A14 is displayed, when the contraindication food “tuna” is not included in the food product to eat, the patient A makes a setting that the food product does not include tuna by operating a button displaying a text “No” on the food ingredient check screen. Then the mobile terminal device 11 displays a mark “0,” which gives rise to safety, together with a message to the effect that there is no risk of the combination, as in an illustration indicated by an arrow A16. In this example, as a message indicating no risk, “There is no risk found in concurrent ingestion of the drug that Mr./Ms. A is taking and this menu” is displayed.

In addition, when an image of the meal is captured as in the illustration indicated by the arrow A13 and a comparison result between identified food product and a user contraindication database determines that the food product that the patient A is going to eat is not a contraindication food, the message indicated by the arrow A16, for example, is displayed.

In this manner, by preparing a user contraindication database in advance, it is possible to provide a user (patient) with appropriate information on drugs and food products readily and promptly from the food product to eat and a user contraindication database. As a result, the user (patient) can immediately find whether or not there is a combining risk in food products that the user is going to eat through a simple operation of capturing an image of the food products that the user is going to eat.

[Configuration Examples of Information Processing System]

Next, an explanation of specific embodiment adopting the present disclosure is provided.

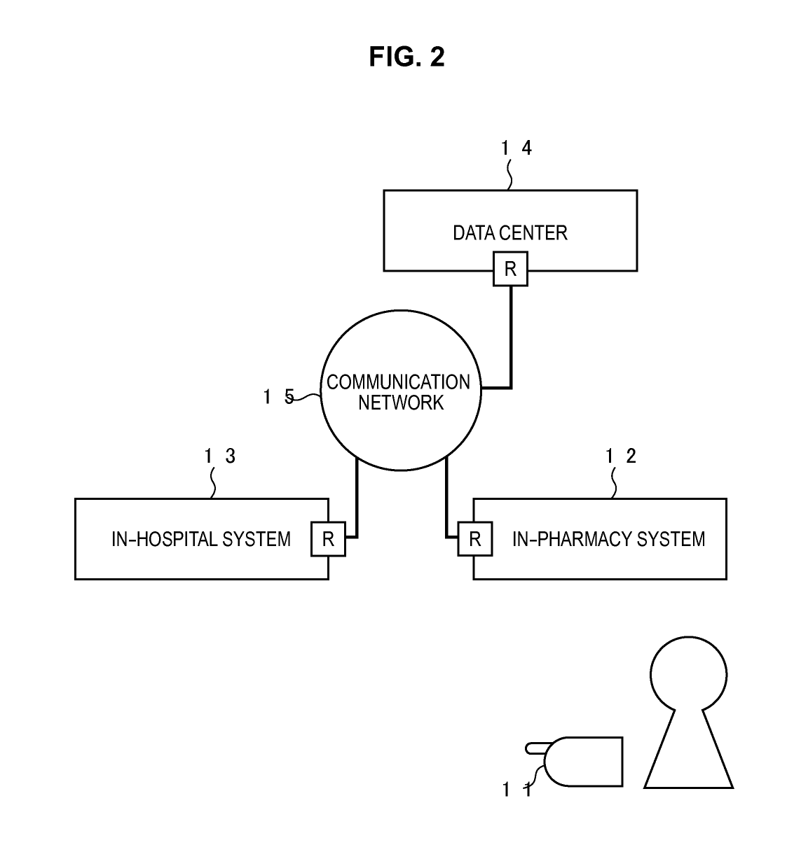

FIG. 2 is a diagram illustrating a configuration example of one of embodiments of an information processing system adopting the present disclosure. In FIG. 2, portions corresponding to those in FIG. 1 are denoted with the same reference numerals and the explanations of these portions are omitted accordingly.

The information processor system in FIG. 2 is configured of a mobile terminal device 11, an in-pharmacy system 12, an in-hospital system 13, and a data center 14, and the in-pharmacy system 12 through the data center 14 are connected to each other via a communication network 15 of a wired or wireless network such as the Internet.

The mobile terminal device 11 includes a mobile phone or a digital camera owned by a user (patient), communicates with the in-pharmacy system 12 through the data center 14 via the communication network 15 or other communication network not illustrated in the drawing, and exchanges information, when necessary.

The mobile terminal device 11 also records an individual identifying ID that is an ID unique to the user. Although the individual identifying ID is identification information that can uniquely identify the user, in general, the individual identifying ID is considered as information with which, when another person obtains the individual identifying ID, the user himself/herself identified by the individual identifying ID is not identified (or is difficult to identify).

The in-pharmacy system 12 is provided in a pharmacy at which the user purchases the prescribed drugs and is configured of one or more devices. The in-pharmacy system 12 reads out the individual identifying ID from the mobile terminal device 11 via proximity communication such as non-contact communication with the mobile terminal device 11 and performs various processing in response to input operations of pharmacists.

In addition, in the in-pharmacy system 12, personal/medication history information including personal information of a user who is a patient, data on medication history (hereinafter referred to as drug history data), dispensing pharmacy ID to identify the in-pharmacy system 12, and a user ID in dispensing pharmacy is recorded for each of users.

The drug history data of each user includes information on drug dispensed for the user in a pharmacy, information on the prescription of the drug, and medication history ID to identify the drug history data. More specifically, drug history data includes, for example, information indicating prescribed drugs and information such as the date of prescription, the length of prescription, and medication history ID.

Moreover, the user ID in dispensing pharmacy included in the personal/medication history information is an ID that allows only the devices constituting the in-pharmacy system 12 to identify a user, and it is information that is not able to directly identify the user even if another person obtains the information.

The in-pharmacy system 12 generates and records personal/medication history information, when necessary, and transmits drug history data included in the personal/medication history information to the data center 14.

The in-hospital system 13 is provided in a hospital to which the user who is a patient goes and is configured of one or more devices. The in-hospital system 13 reads out the individual identifying ID from the mobile terminal device 11 via proximity communication such as non-contact communication with the mobile terminal device 11 and performs various processing in response to input operations of doctors.

In addition, in the in-hospital system 13, personal/diagnosis information including personal information of a user who is a patient, data on diagnosis (hereinafter referred to as diagnosis data), medical institution ID to identify the in-hospital system 13, and a user ID in medical institution is recorded for each of users.

It should be noted that the user ID in medical institution included in the personal/diagnosis information is an ID that allows only the devices constituting the in-hospital system 13 to identify a user, and it is information that is not able to directly identify the user even if another person obtains the information.

The in-hospital system 13 generates and records personal/diagnosis information, when necessary, and transmits diagnosis data included in the personal/diagnosis information to the data center 14.

The data center 14 is configured of one or more devices, receives and records drug history data and diagnosis data from the in-pharmacy system 12 and the in-hospital system 13, and transmits these types of data to the in-pharmacy system 12 and the in-hospital system 13, when demanded. In other words, the drug history data and the diagnosis data recorded in the data center 14 are shared by each of the in-pharmacy system 12 and the in-hospital system 13.

The data center 14, when receiving drug history data or diagnosis data, updates user medication history information. The user medication history information includes a user individual identifying ID, a dispensing pharmacy ID or medical institution ID, a user ID in dispensing pharmacy or a user ID in medical institution, drug history data or diagnosis data, and contact information such as user's e-mail address.

The data center 14 also records the above-described combination database, generates a user contraindication database for each user based on the combination database and the user medication history information, and transmits the user contraindication database to the mobile terminal device 11.

[Configuration Example of Mobile Terminal Device]

Next, explanations of more detailed configurations of the mobile terminal device 11, the in-pharmacy system 12, and the data center 14 in FIG. 2 are provided.

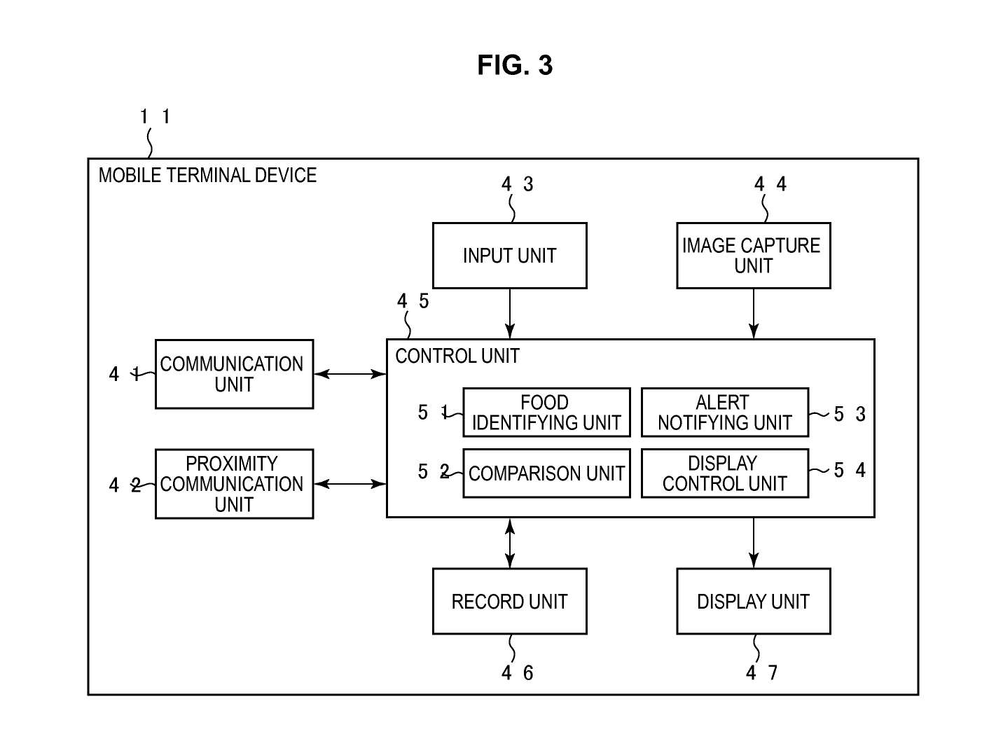

Firstly, the configuration of the mobile terminal device 11 is explained. FIG. 3 is a block diagram illustrating a configuration example of the mobile terminal device 11.

The mobile terminal device 11 is configured of a communication unit 41, a proximity communication unit 42, an input unit 43, an image capture unit 44, a control unit 45, a record unit 46, and a display unit 47.

The communication unit 41 communicates with external devices such as the data center 14, receives various data to supply it to the control unit 45, and transmits data supplied from the control unit 45. The proximity communication unit 42 makes non-contact communication with the in-pharmacy system 12 or the in-hospital system 13, transmits an individual identifying ID read out from the record unit 46 through the control unit 45, and receives necessary information to supply it to the control unit 45.

The input unit 43 includes an input button, a touch panel, and a microphone, for example, and supplies information or voice input by a user to the control unit 45. The image capture unit 44 includes a camera, captures an image of a desired subject, and supplies the obtained image to the control unit 45.

It should be noted that in the following descriptions, from among the obtained images captured by the image capture unit 44, images used for identifying presence/absence of contraindication in combinations, i.e., images of food products that a user is going to eat, are also referred to as food images. In addition, a food product to be a subject of a food image is hereinafter specifically referred to as a determination target food.

The control unit 45 controls operations of the entire mobile terminal device 11. The control unit 45 includes a food identifying unit 51, a comparison unit 52, an alert notifying unit 53, and a display control unit 54.

The food identifying unit 51 identifies a determination target food based on a food image from the image capture unit 44 or voice from the input unit 43. The comparison unit 52 compares the user contraindication database recorded in the record unit 46 with the determination target food and identifies whether or not the determination target food contains contraindication ingredients.

The alert notifying unit 53 issues an alert to a user when a contraindication ingredient is contained in the determination target food. For example, the alert to a user is issued as a display of an alert message on the display unit 47 by means of the display control unit 54 or an output of a voice message from a speaker, which is not illustrated in the drawing. The display control unit 54 controls display of various messages or images on the display unit 47.

The record unit 46 records programs executed by the control unit 45, user contraindication databases, and individual identifying IDs, supplies these types of data to the control unit 45 when necessary. The display unit 47 includes a liquid crystal display panel and the like and displays various images or text messages based on the data supplied from the control unit 45.

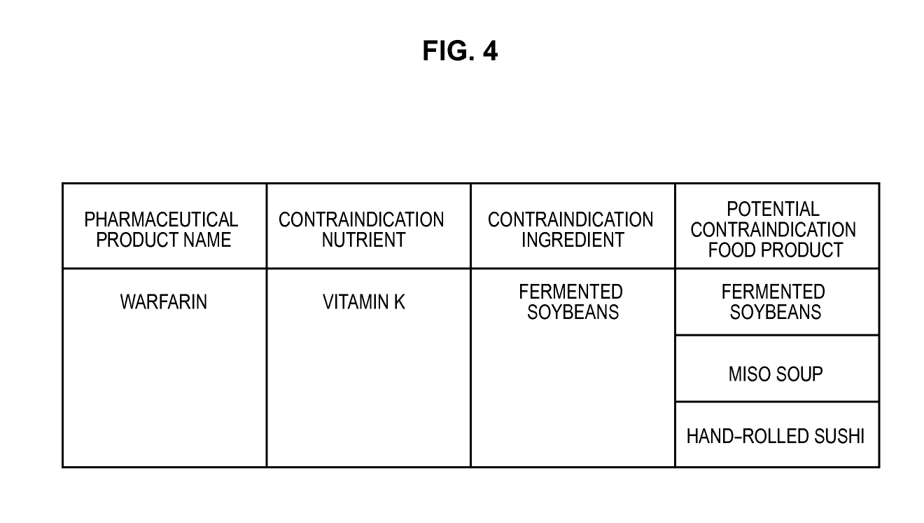

Moreover, a user contraindication database obtained from the data center 14 and recorded in the record unit 46 includes information indicating pharmaceutical product names, contraindication nutrients, contraindication ingredients, and contraindication foods, as described in FIG. 4, for example.

In the example in FIG. 4, the user contraindication database includes “warfarin”, the pharmaceutical product name of a drug that the user is taking, and “vitamin K”, a contraindication nutrient of the drug. In addition, “fermented soybeans” is included as a contraindication ingredient containing the contraindication nutrient “vitamin K”, and “fermented soybeans”, “miso soup”, and “hand-rolled sushi” are also included as contraindication foods that may contain the contraindication ingredient “fermented soybeans”.

It should be noted that when a combination database, which is used for generating a user contraindication database, is generated, existing information may be used as information on the combinations of drugs with contraindication nutrients. Commonly distributed databases listing contraindicated combinations of nutrients and pharmaceutical products that are medically and pharmaceutically revealed may be used as an example.

In the example in FIG. 4, pharmaceutical product name, contraindication nutrients, contraindication ingredients, and contraindication foods that relate only to the contraindication nutrient identified from a contraindicated combination of nutrients and pharmaceutical products are listed in a table to generate a combination database.

In this manner, it is possible not only to enhance efficiency in database creation but also to enhance efficiency in processes by eliminating needs of analyzing nutrients of a food product when detecting contraindication ingredients based on a user contraindication database obtained from the combination database. In particular, at the time of creating a combination database or a user contraindication database, by listing only minimum necessary data from contraindicated combinations medically and pharmaceutically revealed at present in a table, it is possible to enhance efficiency of database creation and update.

Moreover, in the following descriptions, in the user contraindication database, a portion of contraindication ingredients written in a field “contraindication ingredient” is also referred to as a contraindication ingredient list, and a portion of contraindication foods written in a field “potential contraindication food” is also referred to as a contraindication food list.

Furthermore, the user contraindication database in FIG. 4 includes a field “contraindication nutrient.” However, information on contraindication nutrients does not have to be included in the user contraindication database or the combination database.

[Configuration Example of In-Pharmacy System]

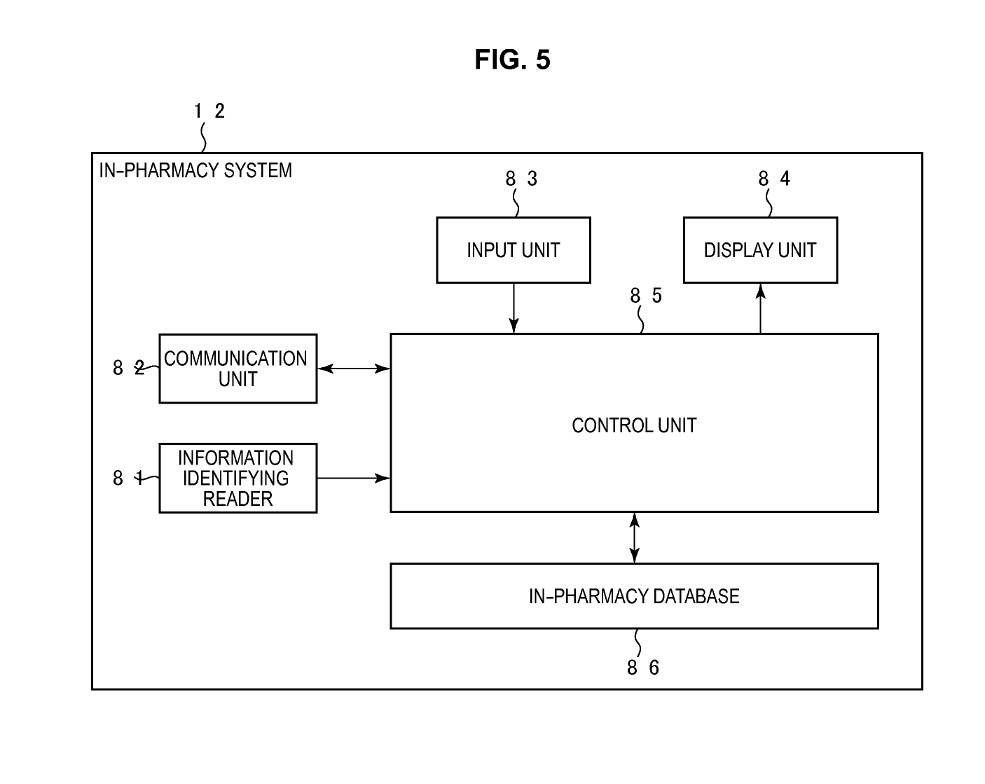

FIG. 5 is a diagram illustrating a configuration example of the in-pharmacy system 12. It should be noted that although the in-pharmacy system 12 is configured of a single device in FIG. 5, the in-pharmacy system 12 may be configured of multiple devices.

The in-pharmacy system 12 includes an information identifying reader 81, a communication unit 82, an input unit 83, a display unit 84, a control unit 85, and an in-pharmacy database 86.

The information identifying reader 81 makes non-contact communication with the proximity communication unit 42 of the mobile terminal device 11, reads out an individual identifying ID from the mobile terminal device 11, and supplies the ID to the control unit 85. The communication unit 82 communicates with each of devices such as the data center 14 via the communication network 15, receives transmitted information to supply it to the control unit 85, and transmits information supplied from the control unit 85.

The input unit 83 includes a mouse, and supplies a signal in accordance with an operation of pharmacists to the control unit 85. The display unit 84 includes a liquid crystal display panel and the like, and displays images based on data supplied from the control unit 85.

The control unit 85 controls operations of the entire in-pharmacy system 12. The in-pharmacy database 86 records various data such as personal/medication history information and supplies the data to the control unit 85 when necessary.

[Configuration Example of Data Center]

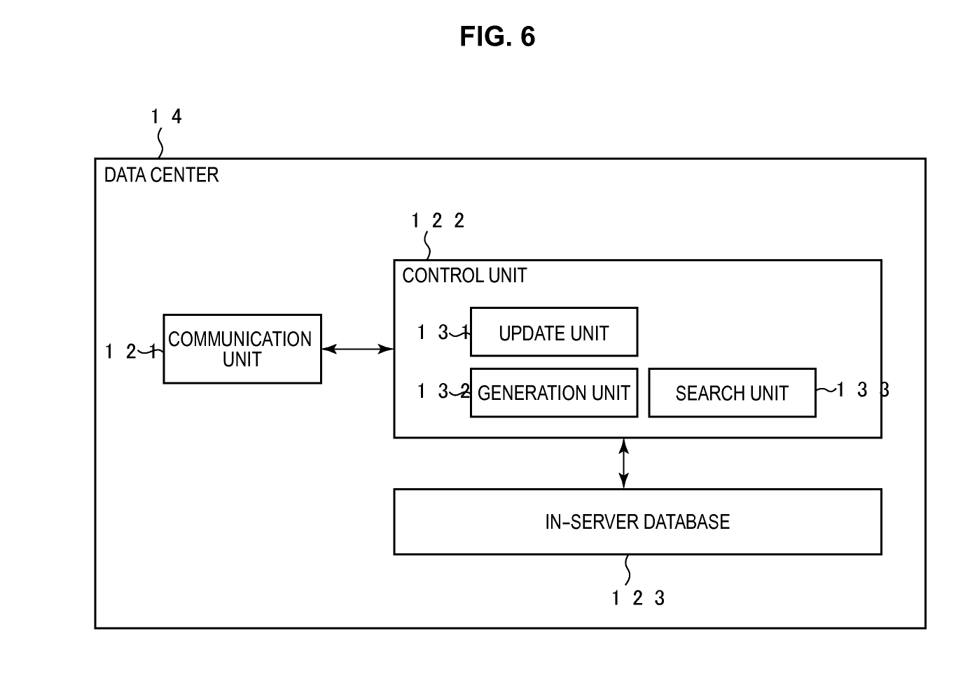

FIG. 6 is a diagram illustrating a configuration example of the data center 14. It should be noted that although the data center 14 is configured of a single device in FIG. 6, the data center 14 may be configured of multiple devices.

The data center 14 includes a communication unit 121, a control unit 122, and an in-server database 123.

The communication unit 121 communicates with the in-pharmacy system 12 and the mobile terminal device 11 through the communication network 15, supplies received information to the control unit 122, and transmits information supplied from the control unit 122.

The control unit 122 controls operations of the entire data center 14. The control unit 122 includes an update unit 131, a generation unit 132, and a search unit 133.

The update unit 131 updates user medication history information recorded in the in-server database 123 based on the received drug history data. The generation unit 132 generates a user contraindication database based on the user medication history information recorded in the in-server database 123 and the combination database. The search unit 133 searches for necessary information from the user medication history information recorded in the in-server database 123.

The in-server database 123 records various data such as user medication history information and combination databases and supplies the recorded data to the control unit 122 when necessary.

For example, a combination database includes information indicating a pharmaceutical product name of a drug, a contraindication nutrient of the drug, a contraindication ingredient that contains the contraindication nutrient, and a contraindication food obtained from the contraindication ingredient. A portion of the information relating to a particular drug in the combination database is extracted to make a user contraindication database.

It should be noted that a combination database may only include information on at least a pharmaceutical product name and a contraindication ingredient, and information on contraindication nutrients, for example, may not be included. In addition, various types of information included in the combination database may be divided into several databases. In such a case, for example, a database including pharmaceutical product names and contraindication nutrients and a database including contraindication nutrients, contraindication ingredients, and contraindication food product are prepared in advance and these databases are used as a single combination database to generate a user contraindication database.

[Explanation of User Contraindication Database Storage Processing]

Next, explanations of operations in the information processor system in FIG. 2 are provided.

For example, when a user who is a patient goes to a pharmacy with his/her prescription and receives a prescribed drug, personal/medication history information is generated in the in-pharmacy system 12 provided in the pharmacy and drug history data etc. is transmitted to the data center 14. In the data center 14, user medication history information is updated on the basis of the drug history data etc., and a user contraindication database is generated and transmitted to the mobile terminal device 11.

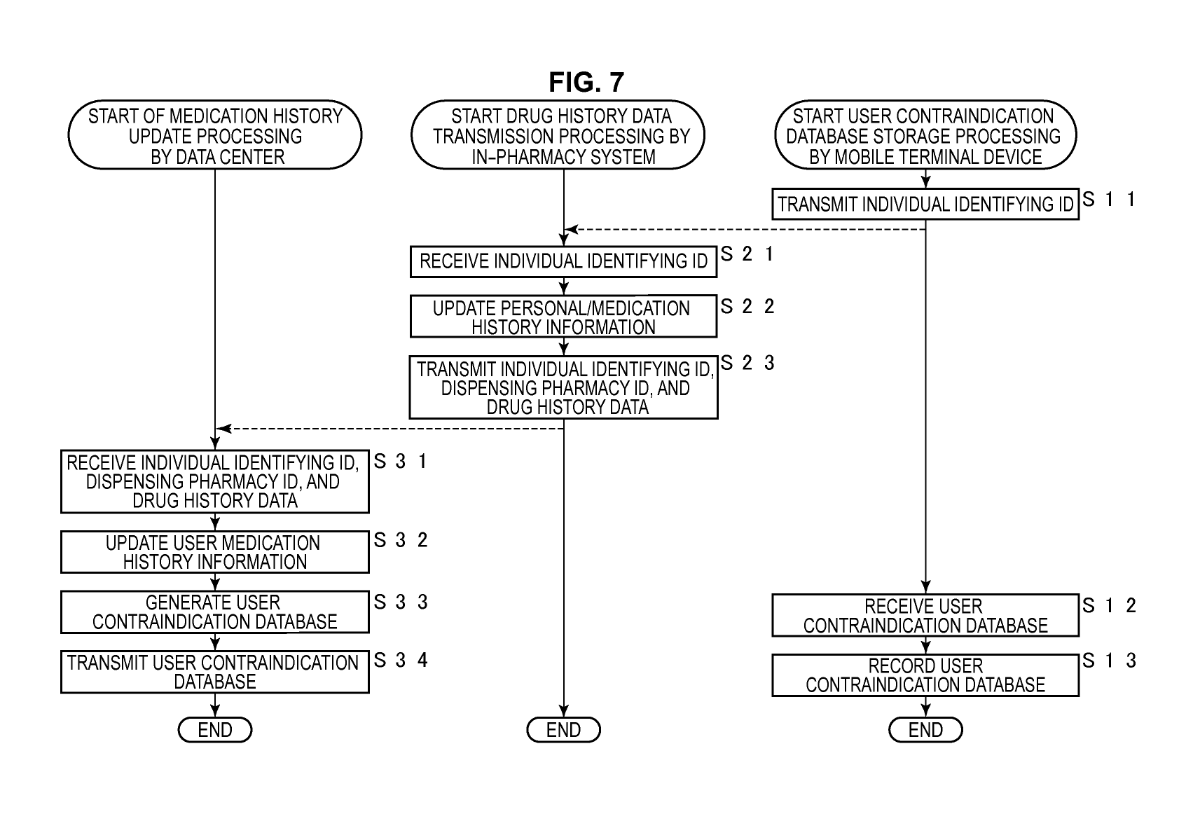

In the following descriptions, user contraindication database storage processing, drug history data transmission processing, and mediation history update processing, which are performed by the mobile terminal device 11, the in-pharmacy system 12, and the data center 14 in the above situation, are explained with reference to a flowchart in FIG. 7.

Firstly, when a user goes to a pharmacy and passes the mobile terminal device 11 over the information identifying reader 81 of the in-pharmacy system 12, the mobile terminal device 11 and the in-pharmacy system 12 start non-contact communication. Then the control unit 45 of the mobile terminal device 11 reads out an individual identifying ID from the record unit 46 and supplies it to the proximity communication unit 42 in response to a request from the in-pharmacy system 12.

In step S11, the proximity communication unit 42 transmits the individual identifying ID supplied from the control unit 45 to the in-pharmacy system 12.

In step S21, the information identifying reader 81 of the in-pharmacy system 12 receives the individual identifying ID transmitted from the proximity communication unit 42 and supplies it to the control unit 85.

The in-pharmacy system 12, then, transmits the individual identifying ID and a dispensing pharmacy ID to the data center 14 through the communication network 15 and acquires information on the user.

For example, the search unit 133 in the data center 14 detects user medication history information including the same individual identifying ID and dispensing pharmacy ID as those received from the in-pharmacy system 12 from among user medication history information recorded in the in-server database 123. The control unit 122 supplies a user ID in dispensing pharmacy and drug history data included in the detected user medication history information to the communication unit 121 to transmit them to the in-pharmacy system 12.

When the user ID in dispensing pharmacy and the drug history data are received from the data center 14, the in-pharmacy system 12 can identify the user from the user ID in dispensing pharmacy. The in-pharmacy system 12 displays the drug history data of the user, when necessary, and a pharmacist or the like makes identity confirmation of the user, and input the drug history data relating to the dispensed drugs by operating the input unit 83.

In step S22, the control unit 85 updates the personal/medication history information based on the newly input drug history data. In other words, the control unit 85 supplies the personal/medication history information including newly generated drug history data to the in-pharmacy database 86 for recording. For example, new drug history data includes information indicating dispensed drugs, the data of prescription of the drugs, the length of prescription of the drugs, and a medication history ID to identify the drug history data.

Moreover, the control unit 85 supplies the individual identifying ID, the dispensing pharmacy ID, and the newly generated drug history data to the communication unit 82.

In step S23, the communication unit 82 transmits the individual identifying ID, the dispensing pharmacy ID, and the drug history data, which are supplied from the control unit 85, to the data center 14 through the communication network 15, and the drug history data transmission processing is terminated.

In step S31, the communication unit 121 of the data center 14 receives the individual identifying ID, the dispensing pharmacy ID, and the drug history data, which are transmitted from the in-pharmacy system 12, and supplies them to the control unit 122.

In step S32, the update unit 131 of the control unit 122 generates user medication history information including the individual identifying ID, the dispensing pharmacy ID, and the drug history data, which are supplied from the communication unit 121, causes the in-server database 123 to record the user medication history information, and thereby updates the user medication history information.

In step S33, the generation unit 132 generates a user contraindication database based on the individual identifying ID and the drug history data, which are supplied from the communication unit 121, and the combination database recorded in the in-server database 123.

For example, when the pharmaceutical product name included in the drug history data is “warfarin”, the generation unit 132 extracts information relating to “warfarin” from the combination database, generates the user contraindication database illustrated in FIG. 4, and supplies the user contraindication database to the communication unit 121.

It should be noted that at the time at which the generation unit 132 generates a user contraindication database, information indicating a valid period of the user contraindication database may be generated based on the length of prescription etc. included in the drug history data, and such information may be transmitted to the mobile terminal device 11 together with the user contraindication database. In such a case, an expired user contraindication database can be deleted in the mobile terminal device 11. For example, information indicating a valid period is recorded with a user contraindication database in the record unit 46, and the control unit 45 monitors the information indicating the valid period. When a valid period of a user contraindication database is expired, the user contraindication database is deleted from the record unit 46.

In step S34, the communication unit 121 transmits the user contraindication database supplied from the control unit 122 to the mobile terminal device 11, and the medication history update processing is terminated. For example, a transmission destination of the user contraindication database is included in the user medication history information recorded in the in-server database 123. It should be noted that it is also possible to make a setting in which a user contraindication database is transmitted to a mobile terminal device 11 that accessed the data center 14. In this case, user identification may be performed by using a medication history ID or an individual identifying ID.

In step S12, the communication unit 41 in the mobile terminal device 11 receives the user contraindication database transmitted from the data center 14 and supplies it to the control unit 45.

In step S13, the control unit 45 supplies the user contraindication database supplied from the communication unit 41 to the record unit 46 for recording, and the user contraindication database storage processing is terminated.

In the above manner, when new drug history data is acquired, the data center 14 generates a user contraindication database based on the drug history data and the combination database, and transmits the user contraindication database to the mobile terminal device 11. Furthermore, the mobile terminal device 11, when receiving the user contraindication database from the data center 14, records the received user contraindication database.

As described above, by generating and storing a user contraindication database in advance, the mobile terminal device 11 can more quickly provide proper information on drugs and food products to its user.

It should be noted that when the drug history data generated in the in-pharmacy system 12 is recorded in the record unit 46 in the mobile terminal device 11 as a medication history record book, the mobile terminal device 11 may directly request that the data center 14 generate a user contraindication database.

In such a case, for example, the control unit 45 in the mobile terminal device 11 extracts a medication history ID included in the drug history data recorded in the record unit 46 and supplies the ID to the communication unit 41. The communication unit 41 transmits the medication history ID supplied from the control unit 45 to the data center 14 to request generation of a user contraindication database.

The communication unit 121 in the data center 14 receives the medication history ID transmitted from the mobile terminal device 11 and supplies the ID to the control unit 122. The generation unit 132 in the control unit 122 generates a user contraindication database based on the medication history ID supplied from the communication unit 121 in response to the request from the mobile terminal device 11. In other words, the generation unit 132 searches the in-server database 123 to retrieve drug history data that includes the same medication history ID as that from the communication unit 121. After that the generation unit 132 generates a user contraindication database from the retrieved drug history data and the combination database recorded in the in-server database 123.

[Explanation of Contraindication Determination Processing]

When a user contraindication database is recorded in the mobile terminal device 11 in the above manner, the user can obtain information on contraindicated combinations through an application etc. that can determine contraindicated combinations by using the user contraindication database.

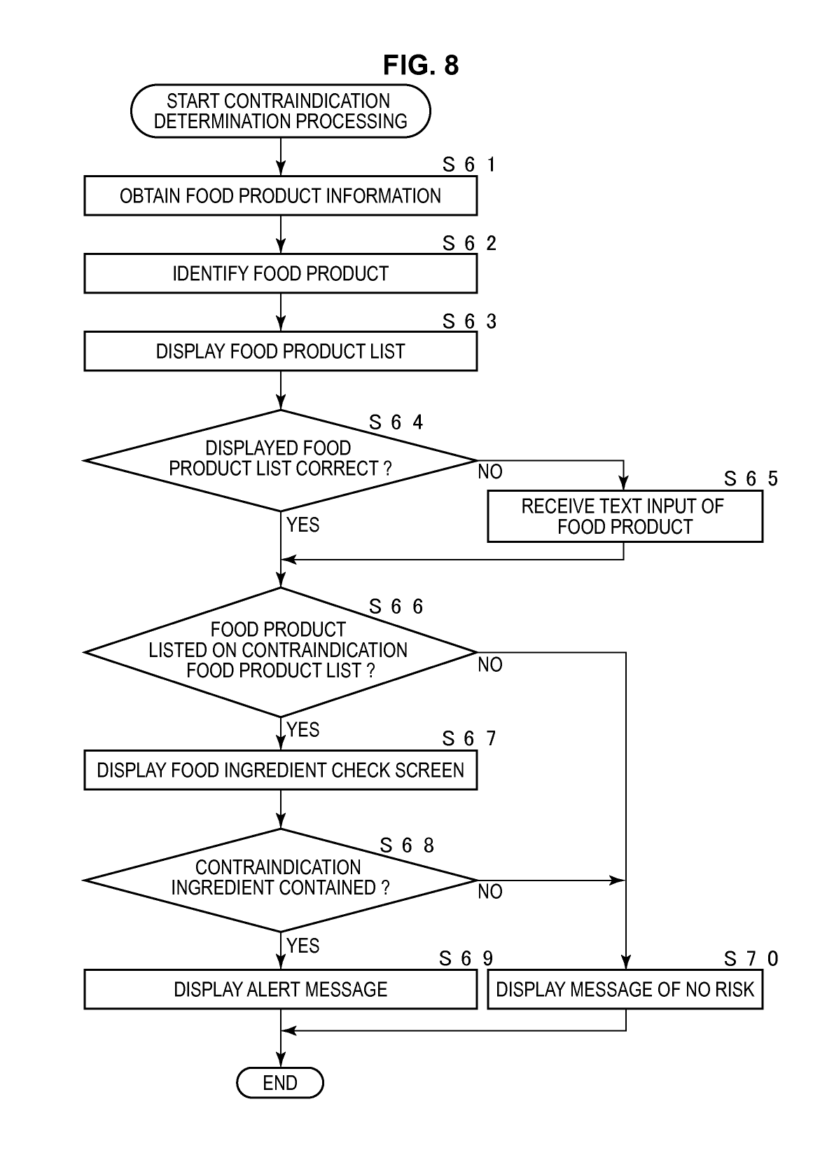

For example, when the user instructs execution of an application program to determine contraindicated combinations by operating the input unit 43, in accordance with the instruction, the control unit 45 executes a program recorded in the record unit 46. Then contraindication determination processing is started by the mobile terminal device 11. In the following descriptions, the contraindication determination processing performed in the mobile terminal device 11 is explained with reference to a flowchart in FIG. 8.

In step S61, the image capture unit 44 obtains food product information.

For example, in response to a user operation, the image capture unit 44 captures a food image of a determination target food product as food product information used to identify the determination target food that the user is going to eat, and supplies the captured image to the control unit 45. Alternatively, a voice signal of user's voice corresponding to a determination target food product name may be obtained as the food product information and may be supplied to the control unit 45 by a microphone serving as the input unit 43.

In step S62, the food identifying unit 51 identifies the determination target food product based on the obtained food product information.

For example, when a food image is obtained as food product information, the food identifying unit 51 extracts a feature amount such as color information and graphic information from the food image and identifies the determination target food product by comparing the extracted feature amount with a feature amount prepared in advance for each food product.

It should be noted that a method to identify a determination target food product by image recognition is not limited to the method that uses a feature amount, but any method can be used. For example, methods of identifying food by pattern matching by using a feature amount, statistical discrimination, or structure discrimination are described in Japanese Laid-Open Patent Publication No. 2011-28382, Japanese Laid-Open Patent Publication No. 2010-286960, and Japanese Laid-Open Patent Publication No. 2004-118562, etc.

Furthermore, when a voice signal is obtained as food product information, the food identifying unit 51 performs voice recognition of the voice signal supplied from the input unit 43 as food product information by using a feature amount and identifies the determination target food product.

It should be noted that identification of a determination target food product may be performed by using both image recognition of a food image and voice recognition of a voice signal, or may be performed by using either one of them.

In step S63, the display control unit 54 causes the display unit 47 to display a food list. In other words, the comparison unit 52 generates a list of one or more determination target food products identified by the food identifying unit 51 as a food list. The display control unit 54 causes the display unit 47 to display a food product check screen that includes the generated food list for checking whether or not the identification result of the determination target food product is correct.

When the food product check screen including a food list is displayed on the display unit 47, the user looks at the food list, checks whether or not the identification result of the determination target foods is correct, and performs an operation in the input unit 43 in accordance with the check result.

In step S64, the comparison unit 52 determines whether or not the food list displayed is correct based on the operation that the user made to the input unit 43.

In step S64, when the food list is determined to be incorrect, the display control unit 54 causes the display unit 47 to display a food product input screen and the processing proceeds to step S65.

In step S65, the comparison unit 52 receives a text input of the food product, receives a supply of a signal in accordance with the input operation of the user from the input unit 43, and identifies a correct determination target food product.

When the food list displayed is incorrect, because identification of the determination target food product in the food identifying unit 51 was not correctly performed, identification of a correct food product is desirable. The user therefore carries out a text input of a correct food product name in an entry field of the food product input screen displayed on the display unit 47 by operating the input unit 43. The comparison unit 52 can obtain a correct determination target food product name from a signal supplied from the input unit 43 in response to the input operation of the user.

When the determination target food product is identified correctly, the processing proceeds to step S66. In this manner, a determination target food product is identified by image recognition, voice recognition and the like, and by having a user input a correct food product name only when the identification result is incorrect, it is possible to reduce a burden of input operation on the user.

In other words, because the user does not have to input determination target food products each time as long as the identification result of a determination target food product is correct, it becomes possible to quickly obtain necessary information on drugs and food products with a simple operation. As a result, user-friendliness can be improved.

It should be noted that although an example in which a user carries out a text input of a correct food product name is explained above, it is also possible to have a user select a correct food product by having the user select a correct food product from a list of food products or by having the user designate an initial letter of the food product or a type of the food product. For example, by displaying a list of food products expected to be a correct determination target food product with check boxes and the like, it is possible to reduce a burden of input operation on the user.

When a correct determination target food product is obtained in step S65, or when the food list is determined to be correct in step S64, in step S66, the comparison unit 52 determines whether or not the identified determination target food product is a food product on the contraindication food product list.

More specifically, the comparison unit 52 makes reference to a contraindication food product list that is a portion, which includes information on contraindication foods, of the user contraindication database recorded in the record unit 46 and compares the contraindication foods on the contraindication food product list with the determination target food product. When the determination target food product is included as a contraindication food on the contraindication food product list, the comparison unit 52 determines that the determination target food product is a food product listed on the contraindication food product list.

When the user contraindication database illustrated in FIG. 4 is recorded in the record unit 46, for example, and the determination target food product is “a hand-rolled sushi”, because the determination target food product “a hand-rolled sushi” is included in the field “potential contraindication food”, the determination target food product “a hand-rolled sushi” is determined to be a food product listed on the contraindication food product list.

In step S66, when the determination target food product is determined to be a food product listed on the contraindication food product list, the comparison unit 52 generates a food ingredient check screen to check whether or not a contraindication ingredient is contained in the determination target food product that is determined to be on the contraindication food product list, and the processing proceeds to step S67.

In step S67, the display control unit 54 supplies the food ingredient check screen generated in the comparison unit 52 to the display unit 47 and causes the display unit 47 to display it.

When the user contraindication database in FIG. 4 is recorded in the record unit 46, for example, and the determination target food product is “a hand-rolled sushi,” an ingredient of the determination target food product “a hand-rolled sushi” included in the contraindication ingredient list as a potential contraindication ingredient is “fermented soybeans.” The comparison unit 52 then generates a food ingredient check screen for selecting whether or not the determination target food product contains the contraindication ingredient “fermented soybeans.”

The food ingredient check screen is, for example, a screen indicated by the arrow A14 in FIG. 1. It should be noted that in the example of FIG. 1, the contraindication ingredient is “tuna.” When there are more than one contraindication ingredient, a list of contraindication ingredients may be displayed on the food ingredient check screen, or a check of whether or not a contraindication ingredient is contained may be performed one by one.

When the food ingredient check screen is displayed on the display unit 47, the user inputs (selects) whether or not the determination target food product contains a contraindication ingredient by operating the input unit 43.

In step S68, the comparison unit 52 determines whether or not the determination target food product contains a contraindication ingredient based on the input operation of the user in the food ingredient check screen, which is, in other words, a signal supplied from the input unit 43 in response to the operation of the user.

When the determination target food product is determined to contain a contraindication ingredient in step S68, in step S69, the display control unit 54 supplies an alert message to call for user's attention to the display unit 47 and causes the display unit 47 to display the message.

In other words, the alert notifying unit 53 generates an alert message that is similar to the alert message indicated by the arrow A15 in FIG. 1, for example, and the display control unit 54 supplies the generated alert message to the display unit 47 and causes the display unit 47 to display the message. When the alert message is displayed, the contraindication determination processing is terminated.

By displaying this alert message, the user can be immediately informed that a contraindication ingredient against the drug that the user is taking is contained in the food menu that the user is going to eat. Here, although display of an alert message is explained as an example of a method of notifying an alert to the user, the alert may be notified through any methods such as an alert message (a text message), voice, or vibration. For example, a voice message may be played together with an alert message.

In addition, when the determination target food product is determined not to be a food product listed on the contraindication food product list in step S66, or when the determination target food product is determined not to contain the contraindication ingredient in step S68, the alert notifying unit 53 displays a message to the effect that there is no risk in step S70.

In other words, the alert notifying unit 53 generates a message to the effect that the determination target food product has no risk of contraindicated combination, and the display control unit 54 supplies the generated message indicating no risk to the display unit 47 and causes the display unit 47 to display the message. As a result, a screen indicated by the arrow A16 in FIG. 1, for example, is displayed on the display unit 47. It should be noted that the message indicating no risk is not limited to a text message, but can be a voice message.

When the message indicating no risk is displayed on the display unit 47, the contraindication determination processing is terminated.

As described above, the mobile terminal device 11 obtains food product information, identifies a determination target food product, compares the identification result with a user contraindication database and identifies whether or not the determination target food product contains a contraindication ingredient. In accordance with the identification result, the mobile terminal device 11 notifies the user of a risk of contraindicated combination by an alert message to call for user's attention.

In this manner, the identification result of the determination target food product is compared with a user contraindication database and whether or not the determination target food product contains a contraindication ingredient is identified while an input operation of the user is received when necessary, and as a result, it becomes possible to provide a user with proper information on drugs and food products in more quick and simple manner.

Particularly, in an information processor system, by making use of immediacy of information update in an electrical medical history record book, which is drug history data and an advantage of uniform management of information on medication history such as drug history data, it is possible to call for user's attention by using the mobile terminal device 11 before the user consumes contraindicated combination of a food product and a drug. In the mobile terminal device 11, by combining an image capture function, a text and voice input function, and a communication function that the mobile terminal device 11 has, users who are not used to IT (Information Technology) such as elderly people can avoid a risk of contraindicated combination with simple operations.

Furthermore, users can obtain proper information on the contraindicated combination by operating the mobile terminal device 11, regardless of the location of the user or time.

It should be noted that although an example in which a user contraindication database is recorded in the mobile terminal device 11 is explained in the above description, the user contraindication database may be recorded in other devices such as the data center 14. In such a case, the mobile terminal device 11 transmits an identification result of a determination target food product etc. to the data center 14 when necessary, and obtains, from the data center 14, determinations results such as whether or not the determination target food product is listed on a contraindication food product list and whether or not the determination target food product contains a contraindication ingredient. In this case, determinations such as whether or not the determination target food product is listed on a contraindication food product list and whether or not the determination target food product contains a contraindication ingredient are made by external devices such as the data center 14.

Moreover, a user contraindication database may be generated in the mobile terminal device 11.

### Second Embodiment

### Configuration Example of Mobile Terminal Device and Data Server

Furthermore, although an example in which identification of a determination target food product from food product information is performed in the mobile terminal device 11 is explained in the above description, the identification of a determination target food product may be performed by external devices such as the data center 14.

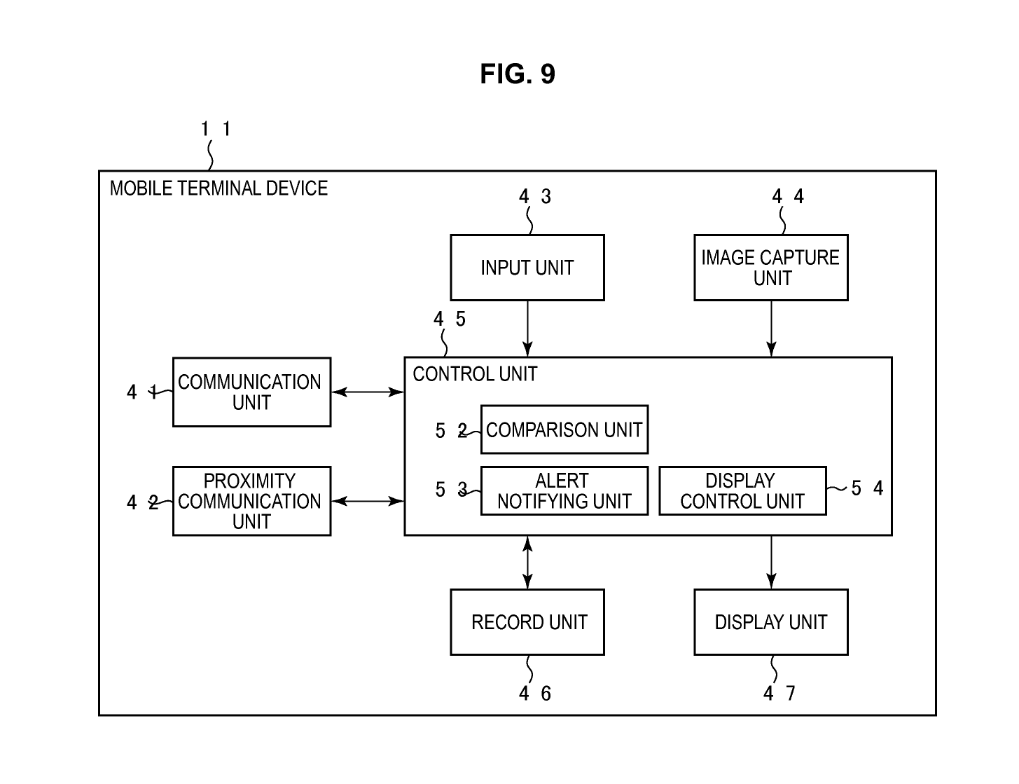

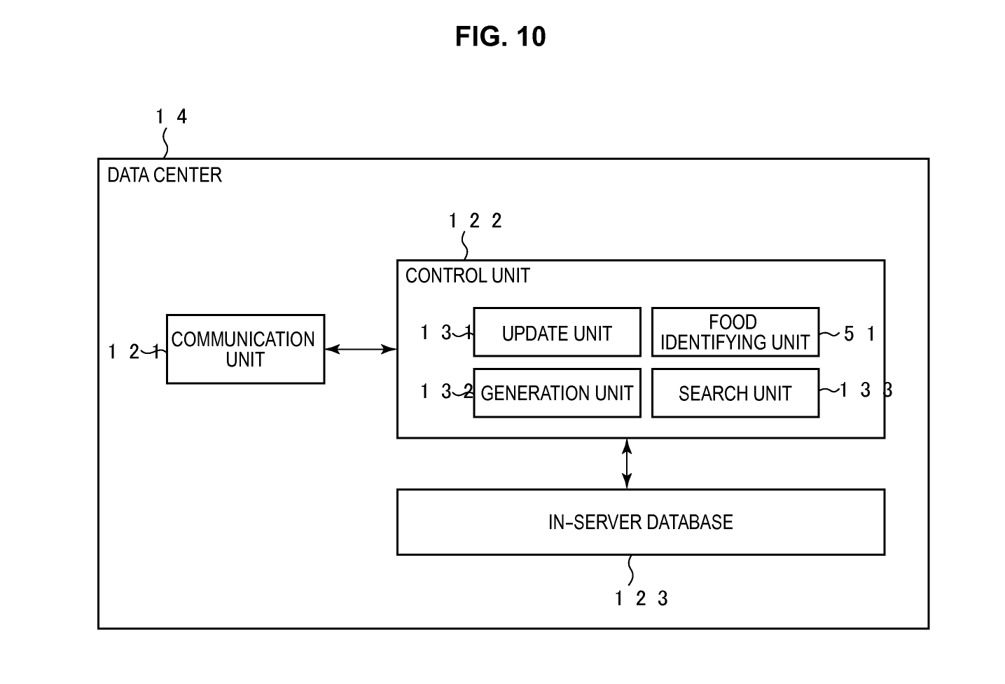

In such a case, for example, the mobile terminal device 11 and the data center 14 are respectively configured as illustrated in FIG. 9 and FIG. 10. It should be noted that in FIG. 9 and FIG. 10, portions corresponding to those in FIG. 3 and FIG. 6 are denoted with the same reference numerals and the explanations of these portions are omitted accordingly.

FIG. 9 is a diagram illustrating another configuration example of the mobile terminal device 11. The mobile terminal device 11 in FIG. 9 is configured of the communication unit 41 to the display unit 47. The configuration of the mobile terminal device 11 in FIG. 9 is different from a configuration of the mobile terminal device 11 illustrated in FIG. 3 in a point that a food identifying unit 51 is not provided in the control unit 45, and the other portions are the same.

FIG. 10 is a diagram illustrating another configuration example of the data center 14. The data center 14 in FIG. 10 is configured of the communication unit 121 to the in-server database 123. The configuration of the data center 14 in FIG. 10 is different from a configuration of the data center 14 illustrated in FIG. 6 in a point that a food identifying unit 51 is not provided in the control unit 122, and the other portions are the same.

[Explanation of Contraindication Determination Processing and Food Identification Processing]

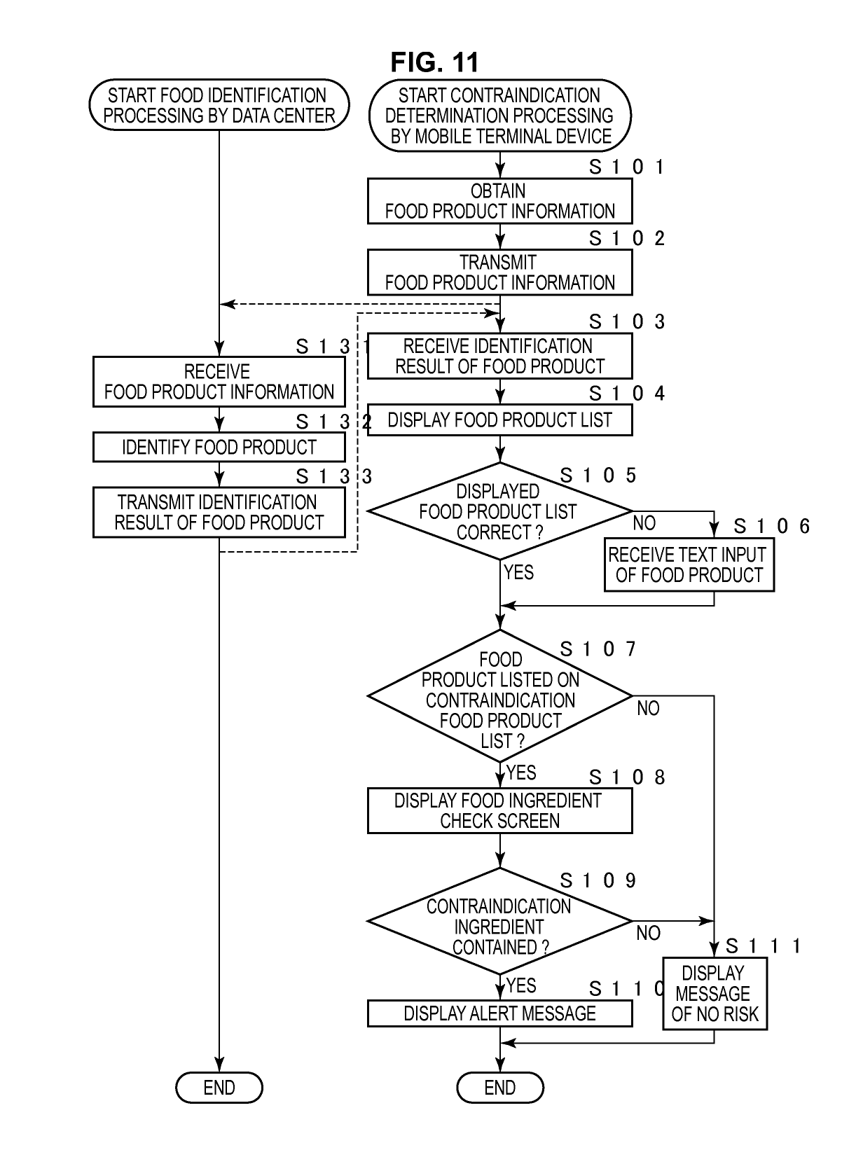

Next, processing when the mobile terminal device 11 and the data center 14 have the respective configurations illustrated in FIG. 9 and FIG. 10 is explained. In other words, in the following descriptions, contraindication determination processing performed by the mobile terminal device 11 and food identification processing performed by the data center 14 are explained with reference to a flowchart in FIG. 11.

In step S101, the image capture unit 44 obtains food product information and supplies it to the control unit 45. In other words, the image capture unit 44 captures an image of a determination target food product and supplies the obtained food image to the control unit 45 as food product information. The control unit 45 supplies the food product information supplied from the image capture unit 44 to the communication unit 41.

It should be noted that in step S101, similarly to the case in step S61 in FIG. 8, user's voice may be obtained as the food product information by a microphone serving as the input unit 43.

In step S102, the communication unit 41 transmits the food product information from the control unit 45 to the data center 14 and requests that the data center 14 identify the food product.

Then, in step S131, the communication unit 121 in the data center 14 receives the food product information transmitted from the mobile terminal device 11 and supplies the information to the control unit 122.

In step S132, the food identifying unit 51 identifies the determination target food product based on the food product information from the communication unit 121 and supplies the identification result to the communication unit 121. In step S132, same processing as that of step S62 in FIG. 8 is performed.

In step S133, the communication unit 121 transmits, to the mobile terminal device 11, the identification result of the determination target food product supplied from the food identifying unit 51, and the food identification processing is terminated.

In step S103, the communication unit 41 of the mobile terminal device 11 receives the identification result of the determination target food product transmitted from the data center 14 and supplies the result to the control unit 45.

When the identification result of the determination target food product is received, processing in step S104 through processing in step S111 are performed afterward, and the contraindication determination processing is terminated. Since the processing in step S104 through processing in step S111 are the same as the processing in step S63 through the processing in step S70 in FIG. 8, explanations are omitted.

In the above manner, the mobile terminal device 11 transmits obtained food product information to the data center 14, receives an identification result of the food product transmitted from the data center 14, and performs determination processing of contraindicated combinations by using the identification result of the food product.

As described above, even in a case in which identification processing of a food product is performed in a device that is different from the mobile terminal device 11, it is possible to provide a user with proper information on drugs and food products in more quick and simple manner.

It should be noted that although an example in which identification of a determination target food product is performed in a device that is different from the mobile terminal device 11 is explained in this description, food product information may also be obtained from an external device.

### Third Embodiment

### Explanation of Contraindication Determination Processing

Although an example of identifying a determination target food product from food product information is explained in the above descriptions, when an IC (Integrated Circuit) tag is provided to a plate on which a food product is served and information on food ingredients of the food product is recorded in the IC tag, for example, food product identification through image recognition becomes unnecessary.

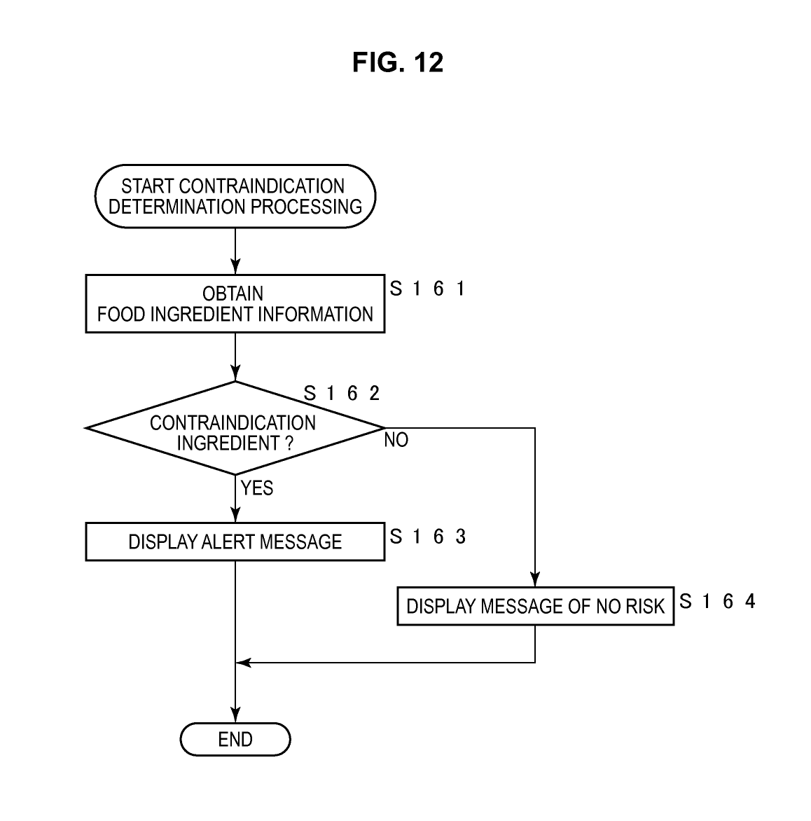

In such a case, the mobile terminal device 11 communicates with the IC tag provided on the plate, reads out food ingredient information indicating ingredients (food ingredients) of the food product from the IC tag, and thereby performs contraindication determination. In the following descriptions, contraindication determination processing when the mobile terminal device 11 in FIG. 3 obtains food ingredient information from an IC tag is explained with reference to a flowchart in FIG. 12.

In step S161, the proximity communication unit 42 in the mobile terminal device 11 makes non-contact communication with an IC tag of a plate on which a determination target food product is served and reads out (obtains) food ingredient information from the IC tag. After that, the proximity communication unit 42 supplies the readout food ingredient information to the control unit 45.

In step S162, the comparison unit 52 compares the food ingredient information supplied from the proximity communication unit 42 with a user contraindication database recorded in the record unit 46 and determines whether or not the food ingredient indicated by the food ingredient information is a contraindication ingredient.

For example, when the food ingredient indicated by the food ingredient information is included in a portion of the contraindication ingredient list of the user contraindication database as a contraindication ingredient, the food ingredient is determined to be a contraindication ingredient.

When the food ingredient is determined to be a contraindication ingredient in step S162, the display control unit 54 supplies to the display unit 47 an alert message to call for user's attention and cause the display unit 47 to display the message in step S163, and the contraindication determination processing is terminated.

In other words, the alert notifying unit 53 generates an alert message that is similar to the alert message indicated by the arrow A15 in FIG. 1, for example, and the display control unit 54 supplies the generated alert message to the display unit 47 and causes the display unit 47 to display the message.

On the other hand, when the food ingredient is determined not to be a contraindication ingredient in step S162, the display control unit 54 causes the display unit 47 to display a message indicating no risk in step S164, and the contraindication determination processing is terminated.

In other words, the alert notifying unit 53 generates a message to the effect that there is no risk of contraindicated combination in the determination target food product, and the display control unit 54 supplies the generated message indicating no risk to the display unit 47 and causes the display unit 47 to display the message. As a result, a screen indicated by the arrow A16 in FIG. 1, for example, is displayed on the display unit 47.

In the above manner, the mobile terminal device 11 obtains food ingredient information, compares the food ingredient information with a user contraindication database, and identifies whether or not a contraindication ingredient is contained in the determination target food product. In accordance with the identification result, the mobile terminal device 11 notifies the user of a risk of contraindicated combination by means of an alert message and calls for user's attention.

As described above, as a result of the mobile terminal device 11 obtaining food ingredient information, it becomes possible to provide a user with proper information on drugs and food products in more quick and simple manner.

It should be noted that the mobile terminal device 11 may obtain information indicating a determination target food product from an IC tag provided on a plate as food product information. In such a case, for example, after the food product information is obtained, processing in step S66 through processing in step S70 in FIG. 8 are performed.

The above-described series of processing can be executed by hardware or can be executed by software. When the series of processing is executed by software, programs that make up the software are installed in a computer. Here, the computer includes a computer incorporated into dedicated hardware and a general-purpose personal computer that can execute various functions by installing various programs.

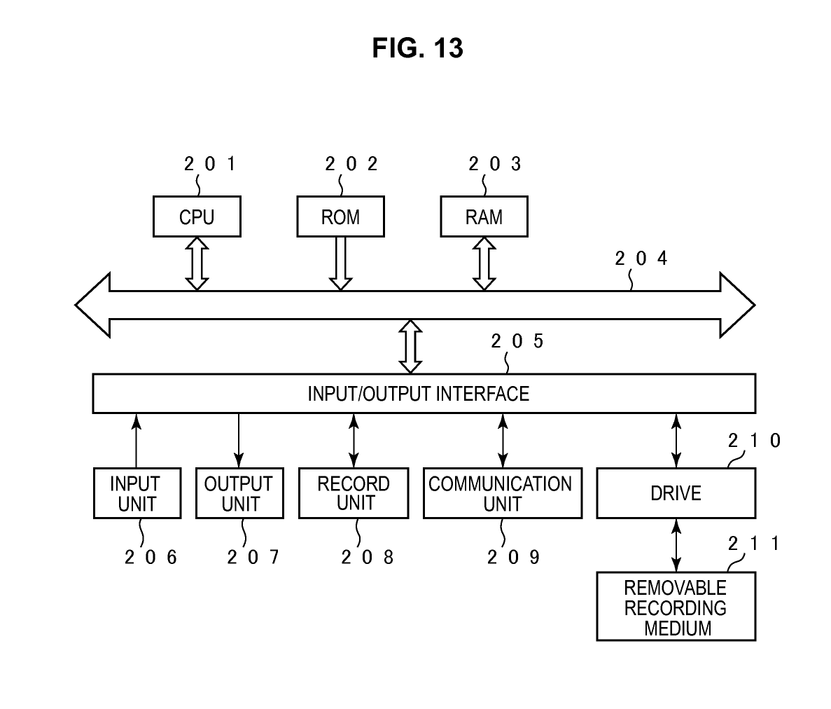

FIG. 13 is a block diagram illustrating a configuration example of hardware of a computer executing the above-described series of processing by using programs.

In the computer, a CPU (Central Processing Unit) 201, a ROM (Read Only Memory) 202, and a RAM (Random Access Memory) 203 are connected to each other by a bus 204.

The bus 204 is further connected to an input/output interface 205. The input/output interface 205 is connected with an input unit 206, an output unit 207, a record unit 208, a communication unit 209, and a drive 210.

The input unit 206 is a keyboard, a mouse, a microphone, an imaging device, or the like. The output unit 207 is a display, a speaker or the like. The record unit 208 is a hard disk, a non-volatile memory or the like. The communication unit 209 is a network interface or the like. The drive 210 drives a removable media 211 such as a magnetic disk, an optical disk, a magneto-optical disk, a semiconductor memory, or the like.

In the computer configured in the above manner, when the CPU 201 loads programs recorded in the record unit 208, for example, into the RAM 203 through the input/output interface 205 and the bus 204 and executes the programs, the above-described series of processing is performed.

Programs executed by the computer (the CPU 201) can be recorded in the removable media 211 serving as a package media, for example, and can be provided. These programs can also be provided through wired or wireless transmission media such as a local area network, the Internet, and digital satellite broadcasting.

In the computer, programs can be installed into the record unit 208 through the input/output interface 205 by placing the removable media 211 in the drive 210. The programs can be received in the communication unit 209 through wired or wireless transmission media and can be installed into the record unit 208. In addition, the programs can be installed in the ROM 202 or the record unit 208 in advance.

It should be noted that programs executed by the computer may be programs processed in chronological order in the sequence explained in this specification, or programs may be processed in parallel or at the appropriate timing such as a timing at which the programs are invoked.

The embodiments of the present disclosure are not limited to the above-described embodiments, but various modification can be made without departing from the scope of the present disclosure.

For example, the present disclosure can have a cloud computing configuration in which one function is shared by plural devices through a network and processing is performed in cooperation.

In addition, each step explained in the above-described flowcharts can be executed by a single device, or can be shared by plural devices and executed.

Moreover, when a single step involves multiple types of processing, the multiple type of processing in one step can be executed in a single device or can be shared by plural devices and executed.

Additionally, the present application may also be configured as below.

(1) An information processor apparatus including:

an obtainment unit obtaining food product information related to a determination target food product that is a subject of contraindication determination;

a comparison unit identifying, based at least on a drug, a contraindication database including information indicating a contraindication ingredient that is contraindicated with the drug, and the food product information, whether or not the determination target food product contains the contraindication ingredient of the drug that a user takes; and

an alert notifying unit issuing an alert notification of a contraindicated combination of the drug and the contraindication ingredient in response to an identification result of the comparison unit.

(2) The information processor apparatus according to (1), wherein

the contraindication database further includes information indicating a contraindication food product that possibly includes the contraindication ingredient,

the obtainment unit obtains a food image obtained by capturing an image of the determination target food product or voice corresponding to a food product name of the determination target food product as the food product information,

the information processor apparatus further includes a food identifying unit identifying the determination target food product based on the food product information, and

the comparison unit identifies whether or not the determination target food product contains the contraindication ingredient by comparing an identification result of the food identifying unit with the contraindication database.

(3) The information processor apparatus according to (2), wherein

when the identification result of the determination target food product identified by the food identifying unit is not correct, the comparison unit identifies whether or not the determination target food product contains the contraindication ingredient by comparing the information indicating the determination target food product input by the user with the contraindication database.

(4) The information processor apparatus according to (2) or (3), further including:

a display control unit displaying a food ingredient check screen when the comparison unit identifies that the determination target food product is included in the contraindication food product of the drug that the user takes in the contraindication database, the food ingredient check screen having input through a selection operation whether or not the contraindication ingredient that is an ingredient of the identified contraindication food product is contained in the determination target food product,

wherein the alert notifying unit issues the alert notification in response to an input operation in the food ingredient check screen.

(5) The information processor apparatus according to any one of (1) to (4), further including:

a database obtainment unit obtaining the contraindication database.

(6) The information processor apparatus according to any one of (1) to (5), further including:

a record unit recording the contraindication database.

(7) The information processor apparatus according to (1), further including:

a communication unit transmitting the food product information, and receiving an identification result of the determination target food product based on the food product information, the identification result being transmitted in response to the transmission of the food product information,

wherein the comparison unit identifies whether or not the determination target food product contains the contraindication ingredient by comparing the identification result of the determination target food product with the contraindication database.

(8) The information processor apparatus according to (1), wherein

the obtainment unit obtains information indicating a food ingredient of the determination target food product as the food product information, and

the comparison unit identifies whether or not the food ingredient of the determination target food product is included in the contraindication database as the contraindication ingredient of the drug that the user takes.

(9) An information processing method including:

obtaining food product information related to a determination target food product that is a subject of contraindication determination;

identifying, based at least on a drug, a contraindication database including information indicating a contraindication ingredient that is contraindicated with the drug, and the food product information, whether or not the determination target food product contains the contraindication ingredient of the drug that a user takes; and

issuing an alert notification of a contraindicated combination of the drug and the contraindication ingredient in response to an identification result of whether or not the contraindication ingredient is contained.

(10) A program for causing a computer to execute processes, the processes including

obtaining food product information related to a determination target food product that is a subject of contraindication determination,

identifying, based at least on a drug, a contraindication database including information indicating a contraindication ingredient that is contraindicated with the drug, and the food product information, whether or not the determination target food product contains the contraindication ingredient of the drug that a user takes, and

issuing an alert notification of a contraindicated combination of the drug and the contraindication ingredient in response to an identification result of whether or not the contraindication ingredient is contained.

(11) An information processor apparatus including:

a record unit recording at least a drug, a combination database including information indicating a contraindication ingredient that is contraindicated with the drug and user medication history information on the drug that a user takes;

a generation unit generating a contraindication database including information indicating the drug that the user takes and the contraindication ingredient of the drug based on the combination database and the user medication history information; and

a communication unit transmitting the contraindication database.

(12) The information processor apparatus according to (11), wherein

the combination database and the contraindication database further include information indicating a contraindication food product that possibly includes the contraindication ingredient.

(13) The information processor apparatus according to (11) or (12), further including:

a food identifying unit identifying a determination target food product that is a subject of contraindication determination based on food product information on the determination target food product,

wherein the communication unit receives the food product information and transmits an identification result of the determination target food product based on the food product information.

(14) An information processing method including:

generating, based on at least a drug, a combination database including information indicating a contraindication ingredient that is contraindicated with the drug and user medication history information on the drug that a user takes recorded in the record unit, a contraindication database including information indicating the drug that the user takes and the contraindication ingredient of the drug; and

transmitting the contraindication database.

(15) A program for causing a computer to execute processes, the processes including

generating, based on at least a drug, a combination database including information indicating a contraindication ingredient that is contraindicated with the drug and user medication history information on the drug that a user takes recorded in the record unit, a contraindication database including information indicating the drug that the user takes and the contraindication ingredient of the drug, and

transmitting the contraindication database.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processor apparatus comprising:
an obtainment unit obtaining food product information related to a determination target food product that is a subject of contraindication determination;
a comparison unit identifying, based at least on a drug, a contraindication database including information indicating a contraindication ingredient that is contraindicated with the drug, and the food product information, whether or not the determination target food product contains the contraindication ingredient of the drug that a user takes; and
an alert notifying unit issuing an alert notification of a contraindicated combination of the drug and the contraindication ingredient in response to an identification result of the comparison unit.

2. The information processor apparatus according to claim 1, wherein
the contraindication database further includes information indicating a contraindication food product that possibly includes the contraindication ingredient,
the obtainment unit obtains a food image obtained by capturing an image of the determination target food product or voice corresponding to a food product name of the determination target food product as the food product information,
the information processor apparatus further includes a food identifying unit identifying the determination target food product based on the food product information, and
the comparison unit identifies whether or not the determination target food product contains the contraindication ingredient by comparing an identification result of the food identifying unit with the contraindication database.

3. The information processor apparatus according to claim 2, wherein
when the identification result of the determination target food product identified by the food identifying unit is not correct, the comparison unit identifies whether or not the determination target food product contains the contraindication ingredient by comparing the information indicating the determination target food product input by the user with the contraindication database.

4. The information processor apparatus according to claim 3, further comprising:
a display control unit displaying a food ingredient check screen when the comparison unit identifies that the determination target food product is included in the contraindication food product of the drug that the user takes in the contraindication database, the food ingredient check screen having input through a selection operation whether or not the contraindication ingredient that is an ingredient of the identified contraindication food product is contained in the determination target food product,
wherein the alert notifying unit issues the alert notification in response to an input operation in the food ingredient check screen.

5. The information processor apparatus according to claim 4, further comprising:
a database obtainment unit obtaining the contraindication database.

6. The information processor apparatus according to claim 5, further comprising:
a record unit recording the contraindication database.

7. The information processor apparatus according to claim 1, further comprising:
a communication unit transmitting the food product information, and receiving an identification result of the determination target food product based on the food product information, the identification result being transmitted in response to the transmission of the food product information,
wherein the comparison unit identifies whether or not the determination target food product contains the contraindication ingredient by comparing the identification result of the determination target food product with the contraindication database.

8. The information processor apparatus according to claim 1, wherein
the obtainment unit obtains information indicating a food ingredient of the determination target food product as the food product information, and
the comparison unit identifies whether or not the food ingredient of the determination target food product is included in the contraindication database as the contraindication ingredient of the drug that the user takes.

9. An information processing method comprising:
obtaining food product information related to a determination target food product that is a subject of contraindication determination;
identifying, based at least on a drug, a contraindication database including information indicating a contraindication ingredient that is contraindicated with the drug, and the food product information, whether or not the determination target food product contains the contraindication ingredient of the drug that a user takes; and
issuing an alert notification of a contraindicated combination of the drug and the contraindication ingredient in response to an identification result of whether or not the contraindication ingredient is contained.

10. A program for causing a computer to execute processes, the processes including
obtaining food product information related to a determination target food product that is a subject of contraindication determination,
identifying, based at least on a drug, a contraindication database including information indicating a contraindication ingredient that is contraindicated with the drug, and the food product information, whether or not the determination target food product contains the contraindication ingredient of the drug that a user takes, and
issuing an alert notification of a contraindicated combination of the drug and the contraindication ingredient in response to an identification result of whether or not the contraindication ingredient is contained.

11. An information processor apparatus comprising:
a record unit recording at least a drug, a combination database including information indicating a contraindication ingredient that is contraindicated with the drug and user medication history information on the drug that a user takes;
a generation unit generating a contraindication database including information indicating the drug that the user takes and the contraindication ingredient of the drug based on the combination database and the user medication history information; and
a communication unit transmitting the contraindication database.

12. The information processor apparatus according to claim 11, wherein
the combination database and the contraindication database further include information indicating a contraindication food product that possibly includes the contraindication ingredient.

13. The information processor apparatus according to claim 12, further comprising:
a food identifying unit identifying a determination target food product that is a subject of contraindication determination based on food product information on the determination target food product,
wherein the communication unit receives the food product information and transmits an identification result of the determination target food product based on the food product information.

14. An information processing method comprising:
generating, based on at least a drug, a combination database including information indicating a contraindication ingredient that is contraindicated with the drug and user medication history information on the drug that a user takes recorded in the record unit, a contraindication database including information indicating the drug that the user takes and the contraindication ingredient of the drug; and
transmitting the contraindication database.

15. A program for causing a computer to execute processes, the processes including
generating, based on at least a drug, a combination database including information indicating a contraindication ingredient that is contraindicated with the drug and user medication history information on the drug that a user takes recorded in the record unit, a contraindication database including information indicating the drug that the user takes and the contraindication ingredient of the drug, and
transmitting the contraindication database.
